(19) United States
(12) Patent Application Publication
(10) Pub. No.: US 2018/0311088 A1
(43) Pub. Date: Nov. 1, 2018

(54) BAG FOR ATTACHING ONTO A WHEELCHAIR

(71) Applicant: DARBI HAYNES-LAWRENCE, NEWBURGH, IN (US)

(72) Inventor: DARBI HAYNES-LAWRENCE, NEWBURGH, IN (US)

(21) Appl. No.: 15/800,299

(22) Filed: Nov. 1, 2017

Related U.S. Application Data
(60) Provisional application No. 62/490,065, filed on Apr. 26, 2017.

(51) Int. Cl. A61G 5/10

(52) U.S. Cl. CPC A61G 5/10

(57) ABSTRACT

The present invention provides a bag for attaching onto a wheel of a wheelchair. The bag includes a substantially planar substrate having an inner surface and an outer surface. The inner surface is configured to engage an outer surface of the wheelchair wheel. A pocket is located in the planar substrate. The pocket includes an opening located in the outer surface of the planar substrate. A closure is provided at the pocket opening and is configured to open and close the pocket. An attachment mechanism is further provided at a periphery of the planar substrate, such that the attachment mechanism is configured to removably attach the bag onto the wheelchair wheel.

### BACKGROUND OF THE INVENTION

### Field of the Invention

The present invention relates to fabric based accessories. More specifically the present invention relates to a bag for attaching onto a wheelchair.

### Description of the Related Art

People who are wheelchair ridden generally find it inconvenient and in some cases impossible to carry around their daily use accessories such as cash, wallets, water bottles and stationary etc. in their pockets. It is also rather difficult for them to carry handbags, as they are already confined within the wheelchair.

The present invention seeks to provide a bag for attaching onto a wheelchair, which will overcome or substantially ameliorate at least some of the deficiencies of the prior art, or at least provide an alternative.

### SUMMARY OF THE INVENTION

It is therefore an object of the present invention to provide a bag for attaching on to a wheelchair.

The present invention meets the object by providing a bag for attaching onto a wheelchair, the bag comprising at least one pocket, a closure provided at the at least one pocket, wherein the closure is configured to open and close the bag and an attachment mechanism provided at a periphery of the bag, wherein the attachment mechanism is configured to attach the bag onto the wheelchair. This way the bag can be attached onto for example a wheel of the wheelchair and accessories needed by a specially-abled user can be carried around in the bag.

In one embodiment of the invention, the bag is made up of a washable polymer based fabric. The polymer based fabrics are cheaply available and easy to work with. Further, the fact that the bag is washable, ensures that the bag can be used for a fairly long duration of time.

In one embodiment of the invention, the bag further comprises one or more ornamentations provided on an outer surface of the bag. The ornamentations allow customization of the bag and makes the bag more aesthetically appealing.

In one embodiment of the invention, the closure further comprises a zipper. The zippers are easy to use and the at least one pocket can be opened and closed using a single hand.

In one embodiment of the invention, the attachment mechanism comprises a plurality of bungee balls and a plurality of respective grommeted openings provided along the periphery of the bag. The bungee balls and the grommeted openings are easy to avail and implement. Also, they allow quick and convenient attachment and detachment of the bag from the wheelchair.

According to one aspect of the present invention, there is provided a bag for attaching onto a wheel of a wheelchair. The bag according to this aspect of the invention includes a substantially planar substrate having an inner surface and an outer surface. The inner surface is configured to engage an outer surface of the wheelchair wheel. A pocket is located in the planar substrate. The pocket includes an opening located in the outer surface of the planar substrate. A closure is provided at the pocket opening and is configured to open and close the pocket. An attachment mechanism is further provided at a periphery of the planar substrate such that the attachment mechanism is configured to removably attach the bag onto the wheelchair wheel.

According to a further aspect of the invention, the planar substrate is formed from a washable polymeric fabric material. The outer surface of the the planar substrate may include an area for placement of ornamentation. The planar substrate preferably has a circular shape, the diameter of which is slightly less than the diameter of the wheelchair wheel.

According to another aspect of the invention, the attachment mechanism comprises a plurality of grommets located about the periphery of the circular planar substrate, and a corresponding plurality of bungee balls for removably attaching the planar substrate to the wheelchair wheel through the corresponding plurality of grommets. Each one of the plurality of bungee balls comprises a length of bungee cord having a first end and a second end. The first and second ends of the bungee cord are fixedly attached to a ball such that the length of bungee cord forms a loop.

A further aspect of the invention is to provide a plurality of pockets located in the planar substrate. A first large pocket may be provided in a first half of the circular planar substrate, and second and third small pockets may be provided in a second half of the circular planar substrate such that each small pocket is provided in a quarter section of the second half of the circular planar substrate. The opening and corresponding closure provided in each of the second and third small pockets may be located proximate to the periphery of the circular substrate. The shape of the opening in each of the second and third small pockets corresponds to the outer periphery of the planar substrate.

An external pocket may be located on the outer surface of the planar substrate. The external pocket may include a plurality of openings with a corresponding plurality of closures. The plurality of openings and closures are spaced about the periphery of the external pocket. The external pocket may have a polygonal shape with an opening and corresponding closure located in each side of said polygon.

The closures according to one further aspect of the invention may be zippers, hook-and-loop fasteners or a combination thereof.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 illustrates a bag for attaching onto a wheelchair, in accordance with a preferred embodiment of the present invention; and

FIG. 2 illustrates the bag attached onto a wheel of a wheelchair, in accordance with a preferred embodiment of the present invention.

### DETAILED DESCRIPTION OF THE INVENTION

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

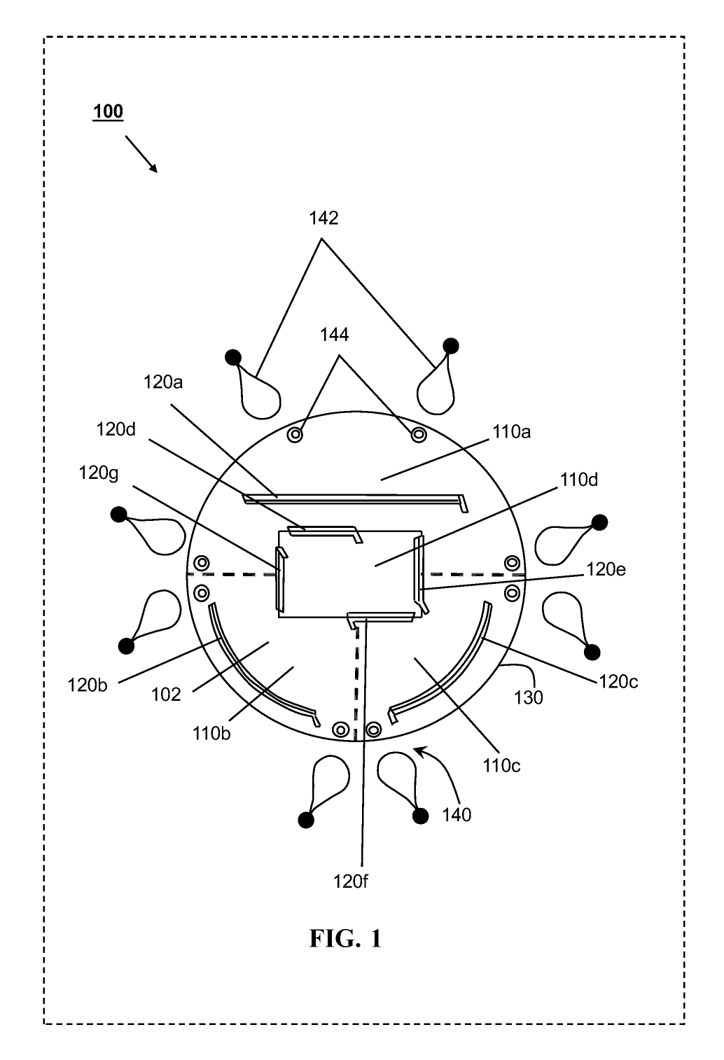

The present invention comprises a bag 100 that is configured to be removably attached to the wheel 220 of a wheelchair 200. As best shown in FIG. 1, in one presently preferred embodiment of the invention, the bag 100 includes at least one pocket 110. In the embodiment shown in FIG. 1, the bag 100 comprises four pockets 110a, 110b, 110c, 110d including one large pocket 110a that is half of the bag 100 adapted for placing large items, two small pockets 110b, 110c of a quarter size of the bag 100 for smaller items and one external pocket 110c for quick access. Further, the bag 100 comprises closures 120 corresponding to the pockets 110. The closures 120 are configured to open and close the pockets 110 in the bag 100. In one embodiment of the invention, the closure 120 comprises a zipper. The zippers are easy to use and each pocket 110 can be opened and closed using a single hand. In another embodiment, the closures 120 comprise loop and hook fasteners. In yet another embodiment, the closures 120 comprise a combination of the zippers and the loop and hook fasteners. According to the preferred embodiment shown in FIG. 1, the external pocket 110c, may include multiple closures 120d, 120e, 120f, 120g which would permit the wheelchair user to quickly and easily access the external pocket 110c regardless of the orientation of the wheel 220 of the wheelchair 210.

Also, the bag 100 comprises an attachment mechanism 140 provided at a periphery 130 of the bag 100. It will be appreciated by a person skilled in the art that although the bag 100 has been illustrated in FIG. 1 to have a circular shape, the bag 100 can have any other regular or irregular shape allowing the bag 100 to be installed onto a desired wheelchair or a portion of the wheelchair. The attachment mechanism 140 is configured to attach the bag 100 onto the wheelchair. In one embodiment of the invention, the attachment mechanism 140 comprises a plurality of bungee balls 142 and a plurality of respective grommeted openings 144 provided along the periphery 130 of the bag 100. In use, the plurality of bungee balls 142 removably attach the bag 100 to the wheelchair, through the plurality of respective grommeted openings 144.

In one embodiment of the invention, the bag 100 is made up of a washable polymer based fabric. The polymer based fabrics are cheaply available and easy to work with. Further, the fact that the bag 100 is washable, ensures that the bag 100 can be used for a fairly long duration of time. In one embodiment of the invention, the bag 100 further comprises one or more ornamentations provided on an outer surface 102 of the bag 100. The one or more ornamentations comprise, but are not limited to, different types of patterns, monograms having names, initials, symbols and numbers etc. of the choice of a user. This allows the bag 100 to be customized and make it more aesthetically appealing to the user.

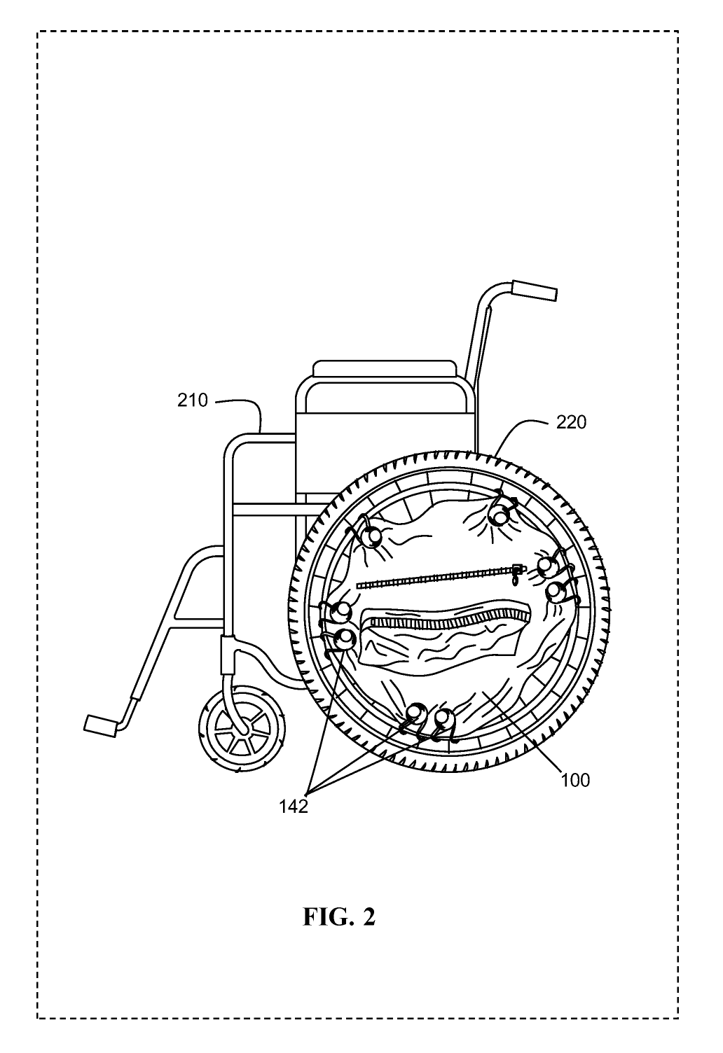

FIG. 2 illustrates the bag 100 attached onto a wheel 220 of a wheelchair 210, in accordance with a preferred embodiment of the present invention. The bag 100 has been attached using the plurality of bungee balls 142 and the plurality of respective grommeted openings 144 (not directly indicated in the FIG. 2). The plurality of bungee balls 142 and the plurality of grommeted openings 144 facilitate easy attachment and removal of the bag 100 from the wheel 220.

The bag 100 for attaching onto a wheelchair offers a number of advantages. First, the bag 100 comprises a number of pockets for carrying a number of much needed accessories. The bag 100 is made up of washable material and allows customization using a number of ornamentations that may be provided onto its outer surface.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

1. A bag for attaching onto a wheel of a wheelchair comprising:
a planar substrate having an inner surface and an outer surface, said inner surface configured to engage an outer surface of the wheelchair wheel;
a pocket located in said planar substrate, said pocket having an opening located in the outer surface of said planar substrate;
a closure provided at said pocket opening, wherein said closure is configured to open and close the pocket; and
an attachment mechanism provided at a periphery of said planar substrate, wherein the attachment mechanism is configured to removably attach the bag onto the wheelchair wheel.

2. The bag according to claim 1 wherein the planar substrate is formed from a washable polymeric fabric material.

3. The bag according to claim 1 wherein said outer surface of the the planar substrate includes an area for placement of ornamentation.

4. The bag according to claim 1 wherein the planar substrate has a circular shape, the diameter of which is slightly less than the diameter of the wheelchair wheel.

5. The bag according to claim 4 wherein the attachment mechanism comprises a plurality of grommets located about the periphery of the circular planar substrate, and a corresponding plurality of bungee balls for removably attaching the planar substrate to the wheelchair wheel through said corresponding plurality of grommets.

6. The bag according to claim 5 wherein each one of said plurality of bungee balls comprises a length of bungee cord having a first end and a second end, said first and second ends of said bungee cord being fixedly attached to a ball such that the length of bungee cord forms a loop.

7. The bag according to claim 4 wherein a plurality of pockets are located in the planar substrate.

8. The bag according to claim 7 wherein a first large pocket is provided in a first half of the circular planar substrate, and second and third small pockets are provided in a second half of the circular planar substrate such that each small pocket is provided in a quarter section of the second half of the circular planar substrate.

9. The bag according to claim 8 wherein the opening and corresponding closure provided in each of the second and third small pockets is located at the periphery of the circular substrate.

10. The bag according to claim 9 wherein the shape of the opening in each of the second and third small pockets corresponds to the outer periphery of the planar substrate.

11. The bag according to claim 8 further comprising an external pocket located on the outer surface of the planar substrate.

12. The bag according to claim 11 wherein said external pocket includes a plurality of openings with a corresponding plurality of closures, said plurality of openings and closures being spaced about the periphery of the external pocket.

13. The bag according to claim 12 wherein the external pocket has a polygonal shape with an opening and corresponding closure located in each side of said polygon.

14. The bag according to claim 7 further comprising an external pocket located on the outer surface of the planar substrate.

15. The bag according to claim 14 wherein said external pocket includes a plurality of openings with a corresponding plurality of closures, said plurality of openings and closures being spaced about the periphery of the external pocket.

16. The bag according to claim 15 wherein the external pocket has a polygonal shape with an opening and corresponding closure located in each side of said polygon.

17. The bag according to claim 1 wherein said closure is a zipper.

18. The bag according to claim 1 wherein said closure is a hook-and-loop fastener.
